(19) United States
(12) Patent Application Publication
(10) Pub. No.: US 2003/0065564 A1
(43) Pub. Date: Apr. 3, 2003

(54) Method of collecting consumer data

(76) Inventors: Jeremy John Carroll, Livorno (IT); Mark Butler, Bristol (GB)

Correspondence Address: HEWLETT-PACKARD COMPANY, Intellectual Property Administration, P.O. Box 272400, Fort Collins, CO, 80527-2400, US

(21) Appl. No.: 10/260,563

(22) Filed: Oct. 1, 2002

(30) Foreign Application Priority Data
Oct. 3, 2001 (GB) 0123672.8

(51) Int. Cl. G06F 17/60; G06F 11/30; G06F 15/00; G21C 17/00; G06F 11/00; G06F 15/173

(52) U.S. Cl. 705/14; 702/186; 702/188; 709/224

(57) ABSTRACT

A method of collecting data relating to the usage of computer equipment by a consumer at the consumer's site includes creating data at the consumer's site relating to the use of the item, and transmitting the data to a remote database for analysis, and once the data is received by the remote database, awarding the consumer a reward.

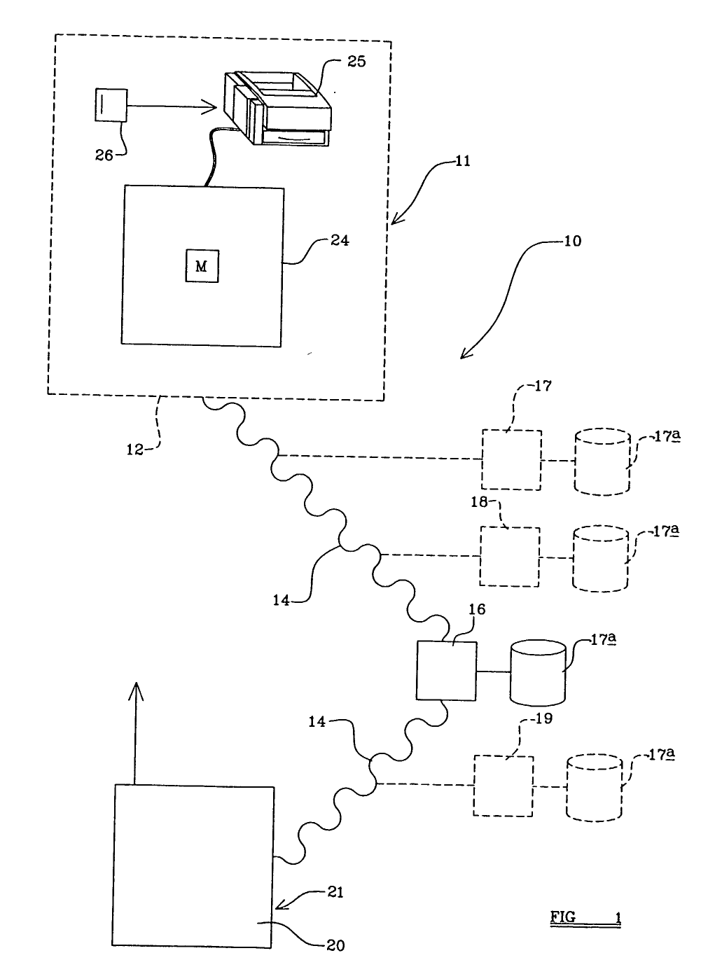

### BACKGROUND TO THE INVENTION

This invention relates to a method of collecting data created when a consumer uses computer equipment, such as a computer peripheral. For example the computer peripheral may include a printing apparatus, connected to a computer. More particularly but not exclusively, the invention relates to a method for collecting data from a private consumer.

To enable a supplier of a consumable, such as for example an ink jet cartridge, to know when the consumable will require replacement, and when to target the consumer with advertising in an effort to sell the consumer a replacement consumable, it is useful for the supplier to collect data concerning the usage of the computer equipment using the consumable. However consumers are wary of supplying data to remote third parties and even where a consumer has no objection to supplying the data, if the data creation or transmission relies on a consumer to take particular actions, data collection tends to be unreliable.

### DESCRIPTION OF THE PRIOR ART

It is known to collect data from private consumers. For example it is known to collect for analysis, data from private consumers relating to television ratings. In such a system, a consumer is contracted to create the data at the consumer's site, and to supply the data for analysis, for a reward. However such a system requires the consumer to take particular actions to create the data and to transmit the data, and the consumer receives a reward for creating and transmitting the data which is unrelated to the nature of the data itself. That is regardless of whether or not a consumer has watched a particular TV programme, or liked or disliked the programme, the consumer is rewarded for creating and transmitting the data, in accordance with the terms of a contract between the supplier and the consumer, not depending on the value of the data.

It is also known to reward a consumer for connecting to a particular web site, for example to allow the consumer to enter a lottery, but the consumer does not transmit data relating to the use of computer equipment which is used for analysis.

It is also known for a third party, such as an Internet Service Provider to create data concerning a consumer's web usage, and to analyse the data in order to determine the consumer's preferences. The consumer may even receive a reward for permitting this data to be created. However in such a method, the data is not created at the consumer's site and transmitted to a remote database.

### SUMMARY OF THE INVENTION

According to a first aspect of the invention we provide a method of collecting data relating to the usage of computer equipment by a consumer at the consumer's site, the method including creating data at the consumer's site relating to the use of the item, and transmitting the data to a remote database for analysis, and once the data is received by the remote database, awarding the consumer a reward.

Thus by operating the method of the invention, the data may be created automatically e.g. each time the computer equipment is used, and transmitted automatically to the remote database, the consumer being encouraged to allow the data to be transmitted to the remote database, by the consumer receiving a reward.

The method may include storing the data as the data is created, in a memory of the computer equipment, and subsequently transmitting the data to the remote database.

By storing the data in a memory, the data may be transmitted to the remote database subsequently to the data being created. Preferably, the computer equipment is capable of network connectivity, whereby the data may be transmitted over a network to the remote database when the computer equipment connects to the network.

For example only, where the network is the Internet, the data may be stored until the computer equipment next connects to the Internet, when the data may be transmitted to the remote database, or the computer may connect automatically to the Internet at predetermined times in order to transmit the data.

Where there is a permanently connection between the consumer's site and a network, such as the Internet, the data created each time the computer equipment is used, may be transmitted immediately or simultaneously upon creation to the remote database.

Further alternatively, the data may be transmitted direct to the remote database via a telecommunications network e.g. at predetermined times.

The remote database may be located at a single remote site or may be a distributed database located at a plurality of sites remote from the consumer's site, the plurality of sites being connected by a network.

The reward awarded to the consumer for transmitting the data is preferably a tangible reward, such as for examples only, a cash reward, points which may be redeemed for cash or another prize such as Air Miles, or a price reduction for a replacement consumable. However the reward may be intangible, for example an opportunity to enter a lottery for a cash or other prize, or points which may be redeemed for an entry in a lottery for a cash or other prize.

In each case though, the reward awarded is preferably dependant upon the value of the data received. For example a reward of a fixed quantum may be awarded for transmitting the data each time valuable data is received, or the quantum of the reward may depend on the amount of computer equipment usage indicated by the data.

Where the computer equipment includes a computer peripheral such as a printing apparatus, which is connected to a computer at the consumer's site, the data may be created by the computer peripheral in response to a query from the computer to which the computer peripheral is connected.

The invention has particularly but not exclusively been developed for collecting data relating to the usage of marking agent such ink from a marking agent cartridge such as an ink cartridge, of computer equipment including a printing apparatus. Thus the data which is created may include information relating to:

the amount of marking agent used during printing, and where the cartridge contains marking agent of more than one colour, the amount of each colour of marking agent used;

the number of pages printed;

the current ink level in the cartridge, or of each colour in the cartridge;

the times of day during which the consumer prints;

the media type on which printing has been performed.

The method may include analysing the data to determine at least one of:

when the consumer is likely to need a replacement cartridge, so that for example a replacement consumable may be offered to the consumer at an appropriate time beforehand;

consumers' patterns of computer equipment usage, so that for example an advertising campaign e.g. on the television, for computer products may be timed not to coincide with when the consumers are most likely to be working on their computers and thus not exposed to such advertising.

According to a second aspect of the invention we provide a method of collecting data relating to the usage of a consumable of an item of computer equipment by a consumer at the consumer's site, the method including creating data at the consumer's site relating to the use of the item, and transmitting the data to a remote database for analysis, and once the data is received by the remote database, awarding the consumer a reward.

The method of the second aspect of the invention may include analysing the data for an individual consumer to determine when the consumable is likely to require replacement, and offering to the consumer replacement consumable prior to the expected expiry of the consumable.

Alternatively or additionally, the method of the second aspect of the invention may include analysing data from a plurality of consumers each of whom has created and transmitted data to the remote database relating to the usage of a consumable of an item of computer equipment by a consumer at the consumer's site, to determine a pattern of computer equipment usage by the consumers.

According to a third aspect of the invention we provide a system for collecting data relating to the usage of computer equipment by a consumer at the consumer's site, the system including at the consumer's site, a processor for creating data relating to the use of the item consumer at the consumer's site, a network connection for transmitting the data to a remote database for analysis, a rewards centre for awarding the consumer a reward once the data is received by the remote database.

The system may include a data storage memory at the consumer's site to store the created data until the data is transmitted to the remote database.

### BRIEF DESCRIPTION OF THE DRAWINGS

The invention will now be described with reference to the accompanying drawing which is a schematic view of a system which may be operated by a method in accordance with the invention.

### DESCRIPTION OF THE PREFERRED EMBODIMENTS

Referring to the drawing there is shown a system 10 which includes at a consumer's site 11, computer equipment 12.

The computer equipment 12 is capable of network connectivity, and thus may be connected to a network 14, e.g. by a modem, leased line, ISDN line or otherwise, the network 14 in this example being the Internet.

Also connected to the network 14 there is a remote database 16. As shown in full lines in the figure, the database 16 is a centralised database, arranged to collect the data from the consumer's site 11 and to store the data in a data store 16a. However alternatively, if desired, as indicated by the dotted lines in the figure, the remote database 16 may be a distributed database 16′ at a plurality of remote sites 17, 18, 19 etc. The database 16 or distributed database 16′ is arranged systematically to collect and store data in respective data stores 16a or 17a, 18a, 19a, e.g. in tables, with the data being accessible from a large number of other sites 16, 17, 18, 19 etc., for analysis of the stored data.

The system 10 further includes a rewards centre 20 which as indicated, is at yet another site 21 connected to the network 14, although the rewards centre 20 may be located at the same site 16 or one of the sites 17, 18, 19 as the remote database.

In a first embodiment, the computer equipment 12 includes a computer 24 to which a computer peripheral being a printer 25 is connected. The printer 25 may be an ink jet printer which is the kind of printer most commonly used by private consumers in the home 11, but may be a laser or other single or multi-colour printing apparatus which utilises marking agent e.g. contained in a cartridge. In each case there is an associated consumable, such as an ink cartridge 26, which is used as the printer 25 is used. In another embodiment, the computer equipment 12 may include a printer 25 only, with the printer 25 enabled to be connected to the network 14 without being connected to a computer 24.

In accordance with the invention, each time the printer 25 is used, data concerning the printer 25 and/or consumable 26 usage, is automatically created in accordance with a computer programme and stored in a memory M of the computer equipment 12 i.e. of the computer 24 where the printer 25 is connected to a computer 24, or a memory M′ within the printer 25 where the printer 25 is connected to directly to the network 14. The computer 24 memory M or the printer 25 memory M′ would typically be a non-volatile random access memory, or a memory disc, or any other medium for persistent storage of the data.

In a less refined embodiment, the data which is created and stored in memory M or M′ may simply be a measure of the number of pages printed by the printer 25; in a more refined embodiment the data which is created and stored may record the ink level in a reservoir of the cartridge 26 containing single colour marking agent, or reservoirs of the cartridge 26 where the cartridge has a plurality of reservoirs e.g. for different colour marking agents. In an even more refined version, where the cartridge 26 is a cartridge for an ink-jet type printer, the data which is created may include a measure of the actual number of droplets of ink used from the ink reservoir of the cartridge 26, or where the cartridge has a plurality of reservoirs for different colour inks, the number of droplets of ink used from each reservoir of the cartridge.

It will be appreciated that from this data, it would be possible to establish when the cartridge is empty or empty to a predetermined degree, and thus when it would be appropriate to offer the consumer a replacement ink cartridge 26. However desirably, the data created each time the printer 25 is used includes time related data, so that not only does the data include information relating to the amount of ink usage, but data relating to when the ink is used. From an analysis of such amount-of-use and time data, it is possible to make a prediction concerning when the consumer is likely to require a replacement cartridge 26.

In accordance with the invention, the created data is stored in the memory M or M′. The next time that the computer equipment 12 connects to the Internet 14, the data in memory M or M′ is transmitted over the network 14 to the remote database site 16 or sites 17, 18, 19 etc., where the data is collected and stored. The thus collected data may then be accessed for example by a supplier of cartridges 26, who may analyse the data to determine when the consumer may require a replacement ink cartridge 26.

In one specific example, the memory M′ of the printer 25 containing the created data transmits the data to the network 14 autonomously of the computer 24. The printer 25 may be adapted to attempt to connect to the network every 15 minutes or so for example.

In another example, the computer 24 sends a query to the management information base of the printer 25 typically using simple network management protocol (SNMP) for a networked printer 25 at the consumer's site, or where the printer 25 is a locally connected printer connected to the computer 24, by a parallel cable for example, using a specific peripheral management language (PML).

In yet another example, instead of creating data and storing the data in a memory M or M′, the data is created e.g. in response to a query generated by a locally connected computer using PML, or in response to a query generated by a network connected computer 24 using SNMP, and the data is immediately transmitted to network 14. For example, the data may be created using a sensor to sense the ink level in a cartridge of the printer 25, or the quantity of some other consumable.

When the supplier determines that it is appropriate to offer the consumer a replacement cartridge 26, an offer for sale may be made by the supplier by snail mail, facsimile, or preferably by E-mailing the consumer to the consumer's computer 24.

In accordance with the invention, to encourage consumers to create and transmit the data to the remote database 16, when the consumer transmits the data to the remote database 16, the rewards centre 20 is actuated to award the consumer a reward, preferably depending on the value of the data transmitted.

For example, the rewards centre 20 may award a reward of a fixed quantum to the consumer only, each time valuable data i.e. data indicating that there has been some use of the printer 25, is transmitted from the consumer's site 11 to the remote database 16, or the quantum of the reward may reflect the amount of usage of the ink consumed by the printer 25. For example where it is determined from the analysis of the data that a first consumer consumes a greater number of cartridges 26 in a given time frame than a second consumer, the first consumer may receive a commensurately greater reward.

The reward which is awarded may be a tangible or intangible reward. Examples of tangible rewards are a cash reward, points which may be redeemed for cash or another prize such as Air Miles, or a price reduction for a replacement consumable e.g. depending upon the amount of consumable usage within a given time period.

Examples of intangible rewards which may be awarded are an opportunity to enter a lottery for a cash or other prize, or points which may be redeemed for an entry in a lottery for a cash or other prize.

In each case rewards are only awarded in response to valuable data being received from the consumer, by which we mean data which indicates at least some consumable usage.

It will be appreciated that in the case where a consumer's site has a permanent network connection, the data may be transmitted to the remote database 16 immediately upon creation as the printer 25 is used so that there is no need to store the data in a memory M for subsequent transmission.

In each case to enable the consumer to create and transmit data automatically, the consumer is provided by a supplier, with an appropriate computer programme. This may be a software programme provided on appropriate media or downloaded from the Internet when the consumer sets up the computer 24 or the printer 25 or another peripheral device. Preferably the consumer is given the choice as to whether to load such a programme rather than for example the programme being hidden and embedded in driver software. Alternatively the programme may be provided in hardware in the computer 24 or the printer 25 or other peripheral device, or even within the consumable 26 where the consumable has a processor to process the programme. In any event a processor will be required to create the data for storage or immediate transmission to the remote database 16, as will a network or direct telecommunication connection, for transmitting the data to the remote database 16. In each case, the consumer will need to register with the remote database 16, so that rewards may properly be awarded to the consumer, providing a return street address, facsimile or E-mail address to which the reward may be directed. Such registration may be achieved for example as the consumer registers his purchase of the computer equipment (e.g. printer 25) with the equipment's supplier over the Internet 14, by methods already well established in the art.

The embodiment described may be further refined in that the data which is created and stored in memory M or M′ or transmitted immediately upon creation to the remote database 16 may include data relating to the kind of media on which printing has been performed by the printer, e.g. plain paper, glossy paper, transparency which may be established from the printer's 25 settings for each printing operation. Thus for example a supplier of media may become aware of a particular kind of media usage and make offers to the consumer to supply such media.

In another embodiment of the method of the invention, the data which is created at and transmitted from the consumer's site 11 includes information as to when the printer 25 and or more generally, the computer equipment 12 has been used. This data may be analysed, particularly from a plurality of consumers who create and supply such data to the remote database 16 to determine patterns of printer 25 and/or general computer equipment 12 usage. By determining such patterns of use a supplier analysing the data transmitted to the remote database 16 may determine appropriate time slots for an advertising campaign.

For example, a supplier of computer equipment who from an analysis of the data stored on the remote database 16, determines that computer usage is greatest between particular hours of a day or on particular days perhaps during particular weeks etc., may decide that those during those hours/days/weeks etc., it would not be worthwhile having a television advertising campaign for his products, because a substantial part of the target audience would be using their computers rather than watching television.

Of course the data which is transmitted from the consumer site 11 or sites to the remote database 16, may contain information both concerning the amount of ink usage, and time patterns of printer 25 and/or general computer equipment 12 usage for alternative analysis.

The invention has primarily been developed for use where the computer equipment usage about which data is created and transmitted to the remote database 16 includes a printer 25 which has a consumable, such as an inkjet, ink, or other marking agent e.g. toner, cartridge.

However the invention may be utilised for other computer equipment. For example, the invention may be used to collect data from a consumer's site relating to usage of a scanner, and/or a digital camera. It is known that the more such computer equipment is used, the more a printer is also used. Thus where a consumer already has a printer which may not be enabled so that data relating to the printer's use can be created and transmitted to the remote database 16, some information concerning the consumer's likely ink usage may be collected along with other information which may enable a supplier to determine when a particular item of computer equipment will need replacement, so that a replacement may be offered at an appropriate time.

Where the invention stores data relating use of a consumable such as ink or other marking agent, instead of storing the data in a memory M of the computer 24 or memory M′ of e.g. a printer 25, the data may be stored even more locally, e.g. in a memory contained within an ink or toner cartridge for example, so that in the event that the cartridge is transferred from one printer to another, the data stored is relevant to the amount of use of the ink/toner etc. from the particular cartridge.

In yet another application of the invention, the computer equipment 12 may be games playing equipment, i.e. a computer programmed to enable a consumer to play games, or a dedicated games machine. By the method of the invention data may be created each time a particular game or particular games is or are played. Such data may simply include an indication that a game or games have been played, and/or may include time related information so that the data created includes information concerning when and how often within a particular time period a game has been played.

By analysing such data transmitted to the remote database 16, preferably for a plurality of consumers, a supplier may determine which games are the most popular, and which games remain the most popular, as well as when an e.g. television, advertising campaign may be inappropriate to screen.

Similarly where the computer equipment includes music and/or video playing peripheral devices, information concerning the most popular music and/or videos and the most likely time periods when these will be played, can be determined from analysing the data created at the consumer's site and transmitted to the remote database 16.

In each case, in accordance with the invention the consumer is awarded a reward for transmitting data to the remote database.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of collecting data relating to the usage of computer equipment by a consumer at the consumer's site, the method including creating data at the consumer's site relating to the use of the item, and transmitting the data to a remote database for analysis, and once the data is received by the remote database, awarding the consumer a reward.

2. A method according to claim 1 wherein the data is created automatically and transmitted automatically to the remote database.

3. A method according to claim 2 wherein the data is created automatically each time the computer equipment is used.

4. A method according to claim 1 wherein the method includes storing the data as the data is created, in a memory of the computer equipment, and subsequently transmitting the data to the remote database.

5. A method according to claim 4 wherein the computer equipment is capable of network connectivity, and the method includes transmitting the data over a network to the remote database when the computer equipment connects to the network.

6. A method according to claim 4 wherein the network is the Internet, and the data is stored until the computer equipment next connects to the Internet, when the data is transmitted to the remote database.

7. A method according to claim 4 wherein the network is the Internet and the computer equipment connects automatically to the Internet at predetermined times in order to transmit the data.

8. A method according to claim 1 wherein there is a permanent connection between the consumer's site and a network and the data created each time the computer equipment is used is transmitted immediately or simultaneously upon creation to the remote database.

9. A method according to claim 1 wherein the data is transmitted direct to the remote database via a telecommunications network at predetermined times.

10. A method according to claim 1 wherein the remote database is located at a single remote site.

11. A method according to claim 1 wherein the remote database is a distributed database located at a plurality of sites remote from the consumer's site, the plurality of sites being connected by a network.

12. A method according to claim 1 wherein the reward awarded to the consumer for transmitting the data is at least one of:
a cash reward;
points which are redeemable for a prize;
a price reduction for a replacement consumable

13. A method according to claim 1 wherein the reward awarded to the consumer for transmitting the data is at least one of:
an opportunity to enter a lottery for a prize;
points which are redeemable for an entry in a lottery for a prize.

14. A method according to claim 1 wherein the reward awarded is dependant upon the value of the data received.

15. A method according to claim 14 wherein a reward of a fixed quantum is awarded for transmitting the data each time valuable data is received.

16. A method according to claim 14 wherein the quantum of the reward is dependant on the amount of computer equipment usage indicated by the data.

17. A method according to claim 1 wherein the method is applied for collecting data relating to the usage of the computer equipment which includes a computer peripheral which is connected to a computer at the consumer's site, the data being created by the computer peripheral in response to a query from the computer to which the computer peripheral is connected.

18. A method according to claim 1 wherein the method is applied for collecting data relating to the usage of marking agent from a marking agent cartridge of the computer equipment, which includes a printing apparatus.

19. A method according to claim 18 wherein the marking agent cartridge contains marking agent of a single colour and the data which is created includes information relating to at least one of:
the amount of marking agent used during printing;
the number of pages printed;
the current marking agent level in the cartridge;
the times of day during which the consumer prints;
the media type on which printing has been performed.

20. A method according to claim 18 wherein the marking agent cartridge contains marking agent of more than one colour, and the data which is created includes information relating to at least one of:
the amount of each colour of marking medium used during printing of each colour ink in the cartridge;
the number of pages printed;
the current level of at least one of the different colour marking agents;
the times of day during which the consumer prints;
the medium type on which printing has been performed.

21. A method according to claim 18 wherein the method includes analysing the data to determine when the consumer is likely to need a replacement cartridge.

22. A method according to claim 21 wherein the method includes offering a replacement consumable to the consumer at an appropriate time before the consumable expires.

23. A method according to claim 18 wherein the method includes analysing the data to determine consumers' patterns of computer equipment usage.

24. A method according to claim 23 wherein the method includes timing an advertising campaign not to coincide with when the consumers are most likely to be using their computer equipment.

25. A method of collecting data relating to the usage of a consumable of an item of computer equipment by a consumer at the consumer's site, the method including creating data at the consumer's site relating to the use of the item, and transmitting the data to a remote database for analysis, and once the data is received by the remote database, awarding the consumer a reward.

26. A method according to claim 25 wherein the method includes analysing the data for an individual consumer to determine when the consumable is likely to require replacement, and offering to the consumer replacement consumable prior to the expected expiry of the consumable.

27. A method according to claim 25 wherein the method includes analysing data from a plurality of consumers each of whom has created and transmitted data to the remote database relating to the usage of a consumable of an item of computer equipment at the consumer's site, to determine a pattern of computer equipment usage by the consumers.

28. A system for collecting data relating to the usage of computer equipment by a consumer at the consumer's site, the system including at the consumer's site, a processor for creating data relating to the use of the item consumer at the consumer's site, a network connection for transmitting the data to a remote database for analysis, a rewards centre for awarding the consumer a reward once the data is received by the remote database.

29. A system according to claim 28 wherein the system includes a data storage memory at the consumer's site to store the created data until the data is transmitted to the remote database.
